(19) United States
(12) Patent Application Publication
(10) Pub. No.: US 2014/0157010 A1
(43) Pub. Date: Jun. 5, 2014

(54) POWER ON AND OFF TEST CIRCUIT

(71) Applicants: Hong Fu Jin Precision Industry (WuHan) Co., Ltd., (US); HON HAI PRECISION INDUSTRY CO., LTD., New Taipei (TW)

(72) Inventors: CHUN-SHENG CHEN, New Taipei (TW); JING WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/721,047

(22) Filed: Dec. 20, 2012

(30) Foreign Application Priority Data
Dec. 4, 2012 (CN) 201210512126.8

(51) Int. Cl. G06F 1/26

(52) U.S. Cl. CPC G06F 1/26
USPC 713/300

(57) ABSTRACT

A power on and off (on/off) test circuit includes a charging and discharging circuit, a control circuit, and a power circuit. The power circuit provides a voltage to the charging and discharging circuit and the control circuit. When a charging voltage of the charging and discharging circuit is greater than or equal to a preset voltage, the charging and discharging circuit discharges and outputs a first control signal to the control circuit, the control circuit controls the computer to be powered on according to the first control signal; when the charging voltage of the charging and discharging circuit is less than the preset voltage, the charging and discharging circuit is charged and outputs a second control signal to the control circuit, the control circuit controls the computer to be powered off according to the second control signal.

### BACKGROUND

1. Technical Field

The present disclosure relates to test circuits, and particularly to a test circuit for testing power on and off (on/off) of a computer.

2. Description of Related Art

At present, the south bridge chip arranged on a motherboard of a computer will lose power after a soft shutdown of the computer. However, when a power on/off test is being executed, a standby power is needed to awake internal modules of the south bridge chip. Thus, the motherboard cannot be used for executing power on/off test for the computer. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

FIGS. 1 and 2 are circuit diagrams of a power on and off test circuit in accordance with an embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

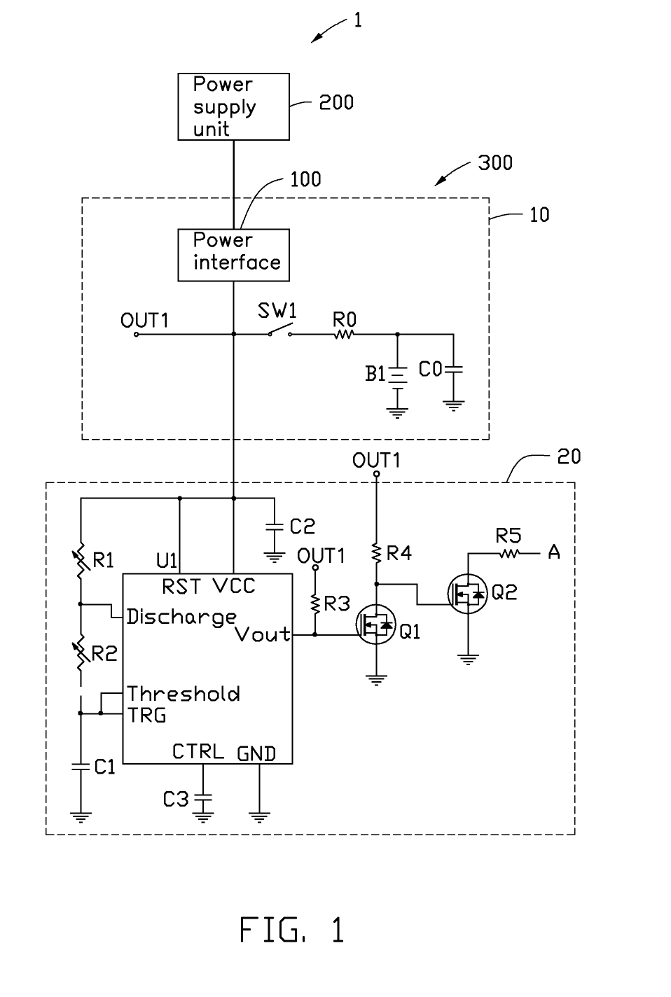

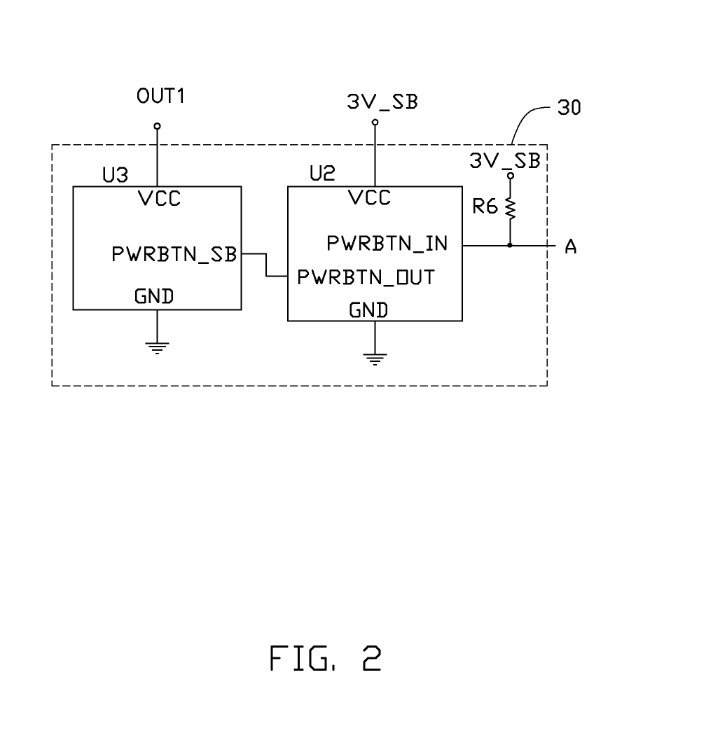

FIGS. 1 and 2 show a power on and off (on/off) test circuit 300 of the embodiment. The power on/off test circuit 300 is arranged on a motherboard of a computer 1 for executing power on/off test for the computer 1. The power on/off test circuit 300 includes a power circuit 10, a charging and discharging circuit 20, and a control circuit 30. The power circuit 10 provides a voltage to the charging and discharging circuit 20 and the control circuit 30. When a charging voltage of the charging and discharging circuit 20 is greater than or equal to a preset voltage, the charging and discharging circuit 20 outputs a first control signal to the control circuit 30. The control circuit 30 controls the computer 1 to be powered on according to the first control signal. When the charging voltage of the charging and discharging circuit 20 discharges to less than the preset voltage, the charging and discharging circuit 20 outputs a second control signal to the control circuit 30. The control circuit 30 controls the computer 1 to be powered off according to the second control signal.

The power circuit 10 includes a battery B1, a switch SW1, a resistor R0, a capacitor C0, a voltage output terminal OUT1, and a power interface 100 connected to a power supply unit 200 of the computer 1. The power interface 100 is connected to the voltage output terminal OUT1 and a first end of the switch SW1. A second end of the switch SW1 is connected to a positive terminal of the battery B1 through the resistor R0. A negative terminal of the battery B1 is grounded. The capacitor C0 is connected between the positive terminal of the battery B1 and ground.

The charging and discharging circuit 20 includes resistors R1-R5, a 555 timer U1, two electronic switches, such as n-channel field effect transistors (FETs) Q1 and Q2, and capacitors C1-C3. A voltage terminal VCC of the 555 timer U1 is connected to the voltage output terminal OUT1, and a reset terminal RST of the 555 timer U1. The resistor R1 is connected between the voltage terminal VCC and a discharging terminal Discharge of the 555 timer U1. The resistor R2 is connected between the discharging terminal Discharge and a trigger terminal TRG of the 555 timer U1. A gate terminal Threshold of the 555 timer U1 is connected to the trigger terminal TRG of the 555 timer U1. The capacitor C1 is connected between the trigger terminal TRG of the 555 timer U1 and ground. The capacitor C3 is connected between a control terminal CTRL of the 555 timer U1 and ground. The capacitor C2 is connected between the voltage terminal VCC of the 555 timer U1 and ground. An output terminal Vout of the 555 timer U1 is connected to a gate of the FET Q1. A source of the FET Q1 is grounded. A drain of the FET Q1 is connected to a gate of the FET Q2, and also connected to the voltage output terminal OUT1 through the resistor R4. The resistor R3 is connected between the gate of the FET Q1 and the voltage output terminal OUT1. A source of the FET Q2 is grounded. A drain of the FET Q2 is connected to the control circuit 30 through the resistor R5. In one embodiment, the resistors R1 and R2 are variable resistors, the charging voltage of the capacitor C1 can be changed through changing the resistances of the resistors R1 and R2.

The control circuit 30 includes a resistor R6, a super input output (SIO) chip U2, and a south bridge chip U3. An input terminal PWRBTN_IN of the SIO chip U2 is connected to the drain of the FET Q2 and also connected to a standby power source 3V_SB through the resistor R6. A voltage terminal VCC of the SIO chip U2 is connected to the standby power source 3V_SB. An output terminal PWRBTN_OUT of the SIO chip U2 is connected to an input terminal PWRBTN_SB of the south bridge chip U3. A voltage terminal VCC of the south bridge chip U3 is connected to the voltage output terminal OUT1.

In use, the switch SW1 is closed, when the computer 1 is not powered on, the battery B1 outputs a first voltage to the 555 timer U1, the FETs Q1 and Q2, and the south bridge chip U3. The voltage output terminal OUT1 outputs the first voltage to charge the capacitor C1 through the resistors R1 and R2. Before the voltage of the capacitor C1 reaches ½ of the voltage of the 555 timer U1, the output terminal Vout of the 555 timer U1 outputs a high level signal. When the voltage of the capacitor C1 rises to be greater than or equal to ½ of the voltage of the 555 timer U1, the capacitor C1 discharges to the discharging terminal Discharge of the 555 timer U1 through the resistor R2. The output terminal Vout of the 555 timer U1 outputs a low level signal. The FET Q1 is turned off. The FET Q2 receives a high level signal from the battery B1 through the voltage output terminal OUT1 and the FET Q2 is turned on. The drain of the FET Q2 outputs a low level signal to the input terminal PWRBTN_IN of the SIO chip U2. The output terminal PWRBTN_OUT of the SIO chip U2 outputs a low level signal to the south bridge chip U3. The south bridge chip U3 controls the computer 1 to be powered on. The power supply unit 200 provides a second voltage to the south bridge chip U3 through the power interface 100 and the voltage output terminal OUT 1.

After the computer 1 is powered on for a while, when the voltage of the capacitor C1 discharges to less than ½ of the voltage of the 555 timer U1, the voltage output terminal OUT1 provides the second voltage to charge the capacitor C1 through the resistors R1 and R2. The output terminal Vout of the 555 timer U1 outputs a high level signal. The FET Q1 is turned on. The drain of the FET Q1 outputs a low level signal. The FET Q2 is turned off. The input terminal PWRBTN_IN of the SIO chip U2 receives a high level signal from the standby power source 3V_SB. The output terminal PWRBTN OUT of the SIO chip U2 outputs a high level signal to the south bridge chip U3. The south bridge chip U3 controls the computer 1 to be powered off. When the voltage of the capacitor C1 rises and reaches ½ of the voltage of the 555 timer U1, the capacitor C1 discharges again. Therefore, the output terminal Vout of the 555 timer U1 alternately outputs a high level signal and a low level signal for executing the power on/off test for the computer 1.

The power on/off test circuit 300 can provide a voltage to the south bridge chip U3 through the battery B1 after the computer 1 is soft shutdown, and execute power on/off test for the computer 1 through the 555 timer U1, the SIO chip U2, and the south bridge chip U3.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power on and off (on/off) test circuit of a computer, the power on/off test circuit comprising:
a charging and discharging circuit;
a control circuit; and
a power circuit to provide a voltage to the charging and discharging circuit and the control circuit;
wherein when a charging voltage of the charging and discharging circuit is greater than or equal to a preset voltage, the charging and discharging circuit discharges and outputs a first control signal to the control circuit, the control circuit controls the computer to be powered on according to the first control signal; when the charging voltage of the charging and discharging circuit is less than the preset voltage, the charging and discharging circuit is charged and outputs a second control signal to the control circuit, the control circuit controls the computer to be powered off according to the second control signal.

2. The power on/off test circuit of claim 1, wherein the power circuit comprises a battery, a switch, a first resistor, a first capacitor, a voltage output terminal, and a power interface, the power interface is connected to the voltage output terminal and a first end of the switch, a second end of the switch is connected to a positive terminal of the battery through the first resistor, a negative terminal of the battery is grounded, the first capacitor is connected between the positive terminal of the battery and ground.

3. The power on/off test circuit of claim 2, wherein the charging and discharging circuit comprises second to fifth resistors, a 555 timer, first and second electronic switches, and second to fourth capacitors, a voltage terminal of the 555 timer is connected to the voltage output terminal and a reset terminal of the 555 timer, the second resistor is connected between the voltage terminal of the 555 timer and a discharging terminal of the 555 timer, the third resistor is connected between the discharging terminal of the 555 timer and a trigger terminal of the 555 timer, a gate terminal of the 555 timer is connected to the trigger terminal of the 555 timer, the second capacitor is connected between the trigger terminal of the 555 timer and ground, the third capacitor is connected between a control terminal of the 555 timer and ground, the fourth capacitor is connected between the voltage terminal of the 555 timer and ground, an output terminal of the 555 timer is connected to a first terminal of the first electronic switch, a second terminal of the first electronic switch is grounded, a third terminal of the first electronic switch is connected to a first terminal of the second electronic switch and also connected to the voltage output terminal through the third resistor, the fourth resistor is connected between the first terminal of the first electronic switch and the voltage output terminal, a second terminal of the second electronic switch is grounded, a third terminal of the second electronic switch is connected to the control circuit through the fifth resistor.

4. The power on/off test circuit of claim 3, wherein the second and third resistors are variable resistors.

5. The power on/off test circuit of claim 3, wherein the control circuit comprises a sixth resistor, a super input output (SIO) chip, and a south bridge chip, an input terminal of the SIO chip is connected to the third terminal of the second electronic switch and also connected to a standby power source through the sixth resistor, a voltage terminal of the SIO chip is connected to the standby power source, an output terminal of the SIO chip is connected to an input terminal of the south bridge chip, a voltage terminal of the south bridge chip is connected to the voltage output terminal

6. The power on/off test circuit of claim 5, wherein the first and second electronic switches are n-channel field effect transistors (FETs), the first to third terminals of the first and second electronic switches correspond to gates, drains, and sources of the FETs.
